(19) United States
(12) Patent Application Publication
(10) Pub. No.: US 2008/0160245 A1
(43) Pub. Date: Jul. 3, 2008

(54) Skin having enameled metal structure for notebook computer

(75) Inventor: Heng-Yen Liu, Jhudong Township (TW)

Correspondence Address: TROXELL LAW OFFICE PLLC, 5205 LEESBURG PIKE, SUITE 1404, FALLS CHURCH, VA, 22041, US

(73) Assignee: Hocheng Corporation, Taipei (TW)

(21) Appl. No.: 11/716,027

(22) Filed: Mar. 9, 2007

(30) Foreign Application Priority Data
Dec. 28, 2006 (TW) 095223054

(51) Int. Cl. B32B 7/00; B32B 15/04; B32B 17/06

(52) U.S. Cl. 428/98; 428/426; 428/457

(57) ABSTRACT

A notebook computer has a skin with an enameled metal structure. With the skin, the notebook computer's surface is prevented from scrape and corrosion with ease of cleaning. Moreover, China-chic beauty and feel are obtained with the skin, which is contrasting to a normal appearance of a common notebook computer.

### FIELD OF THE INVENTION

The present invention relates to a notebook computer skin; more particularly, relates to preventing the notebook computer skin from being scraped or corroded and relates to obtaining China-chic beauty and feel with ease of cleaning.

### DESCRIPTION OF THE RELATED ARTS

A general skin of notebook computer is made of an alloy of aluminum and magnesium to reduce weight. Yet the skin may be scraped and corroded; and is not easily cleaned after being contaminated. In addition, the skin usually becomes colorful by spray paint, which is not obtained by the material of the skin itself. All the above matters make the general skin of notebook computer monotonous and rough together with bad appearance and feel.

A prior art called “A notebook computer skin with fiber lines” comprises stacked layers of fiber lines, where a layer of fiber lines on top has the same fiber knitting direction and angle as those of a layer of fiber lines at bottom. Although the prior art is improved in appearance and in sustainability to a falling-down, its structure is still weak, easily scraped and corroded while in lack of China-chic beauty. Hence, the prior arts do not fulfill users' requests on actual use.

### SUMMARY OF THE INVENTION

The main purpose of the present invention is to prevent a notebook computer skin from being scraped or corroded while obtaining ease of cleaning.

Another purpose of the present invention is to obtain China-chic beauty and feel. To achieve the above purposes, the present invention is a skin having an enameled metal structure for a notebook computer. A first preferred embodiment comprises a metal base layer; an image area on the metal base layer; and a coating layer on the metal base layer and the image area. A second preferred embodiment comprises a shell with a sunk area; and an image unit in the sunk area, where the image unit comprises a metal base layer; an image area on the metal base layer; and a coating layer on the metal base layer and the image area. Accordingly, a novel skin having an enameled metal structure for a notebook computer is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is the perspective view showing the first preferred embodiment according to the present invention;

FIG. 2 is the explosive view showing the first preferred embodiment;

FIG. 3 is the sectional view showing the first preferred embodiment;

FIG. 4 is the perspective view showing the second preferred embodiment;

FIG. 5 is the explosive view showing the first preferred embodiment;

FIG. 6 is the sectional view showing the first preferred embodiment;

FIG. 7 is the explosive view showing the third preferred embodiment; and

FIG. 8 is the sectional view showing the third preferred embodiment.

### DESCRIPTIONS OF THE PREFERRED EMBODIMENTS

The following descriptions of the preferred embodiments are provided to understand the features and the structures of the present invention.

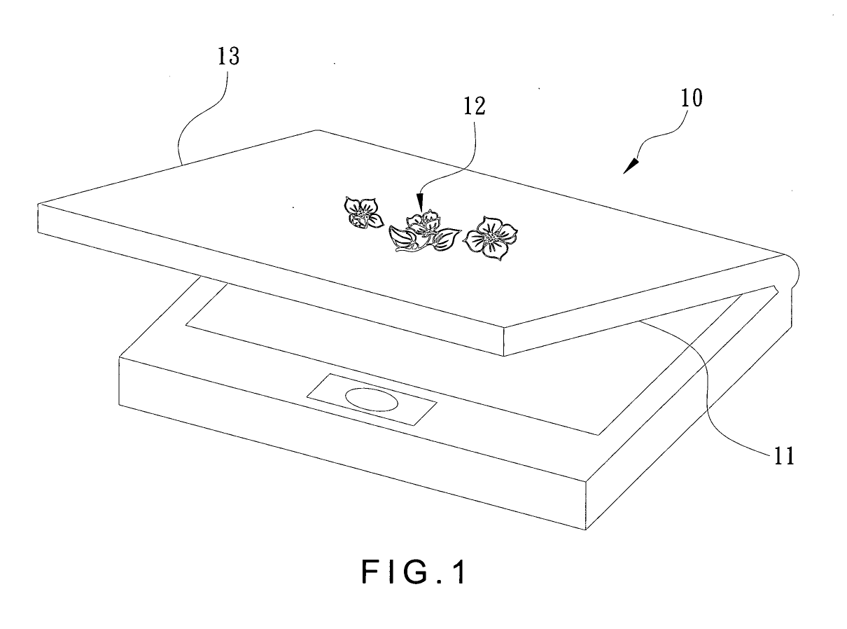

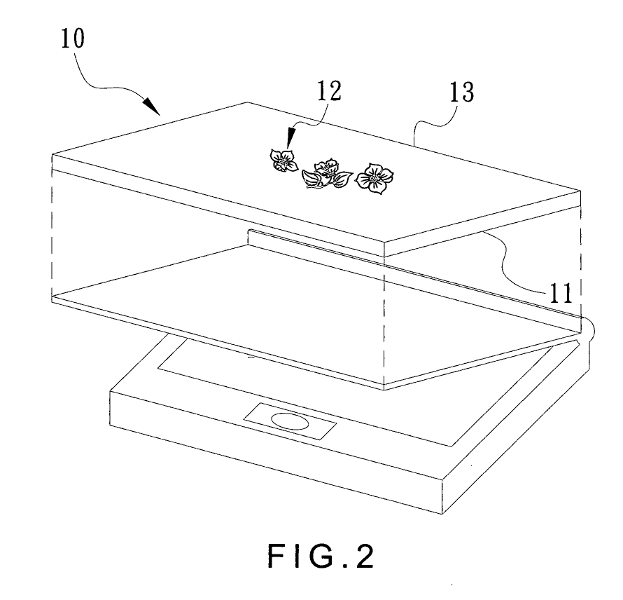

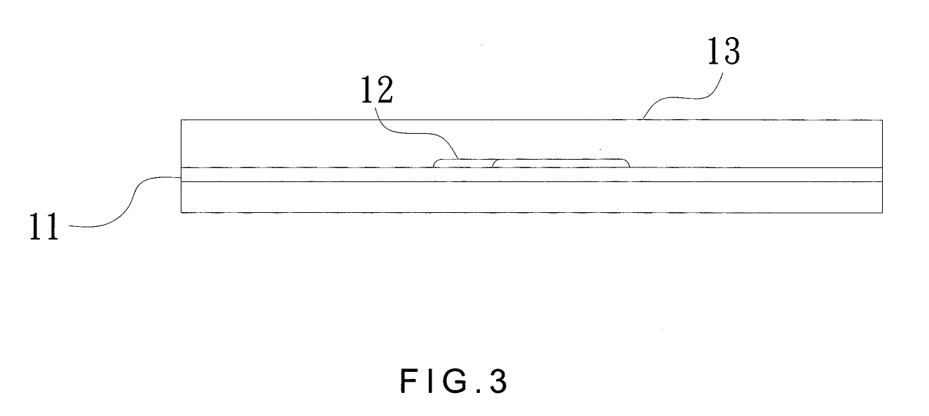

Please refer to FIG. 1 to FIG. 3, which are a perspective view, an explosive view and a sectional view showing a first preferred embodiment according to the present invention. As shown in the figures, the present invention is a skin having an enameled metal structure for a notebook computer, comprising a metal base layer 11, an image area 12 and a coating layer 13, where a notebook computer skin 10 is prevented from being scraped or corroded and China-chic beauty and feel are obtained with ease of cleaning.

The image area 12 is flat or three-dimensionally (3D) hollowed-out and is deposed on the metal base layer 11; and, the coating layer 13 is covered on the metal base layer 11 and the image area 12. Therein, the metal base layer 13 is made of a glass material and a metal oxide; and, the glass material is mixed with a borate or a silicate, where the borate has boron oxide above 25 percents (%) after a reduction.

On fabricating the first preferred embodiment, the metal base layer 11 is formed into a shape of the notebook computer skin 10. Then the image area 12 is hollowed out with a copper wire or a wire of other metal; and the image area 12 is burnt at 900 Celsius degrees (° C.) to be firmly welded on the metal base layer 11. Then the glass material and the metal oxide are coated on the metal base layer 11 and the image area 22, and are filled into the hollowed-out image area 12; and then are burnt at 750° C. to 800° C. to form a coating layer 13 above the metal base layer 11 and the image area 12. In the end, a polish is done to the coating layer 13 as required. Thus, a skin having an enameled metal structure for a notebook computer is obtained.

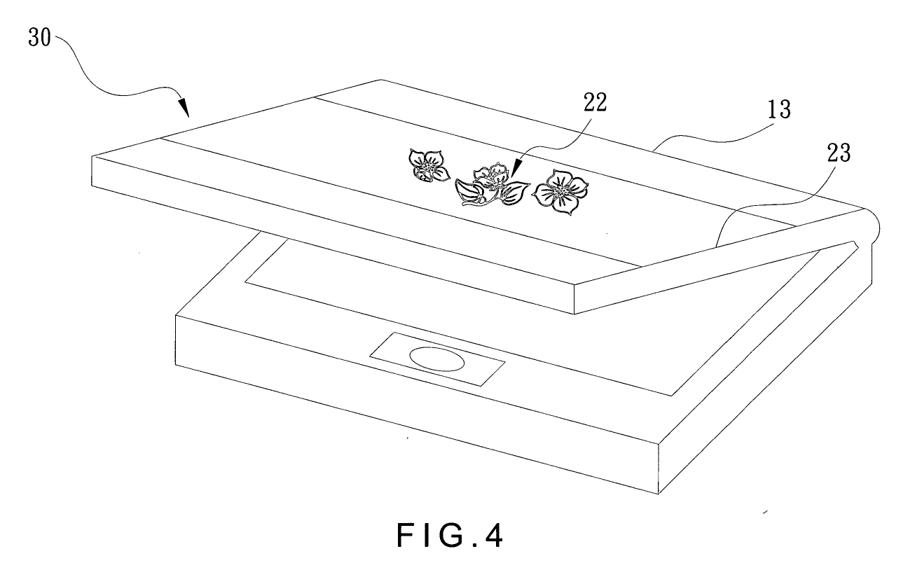

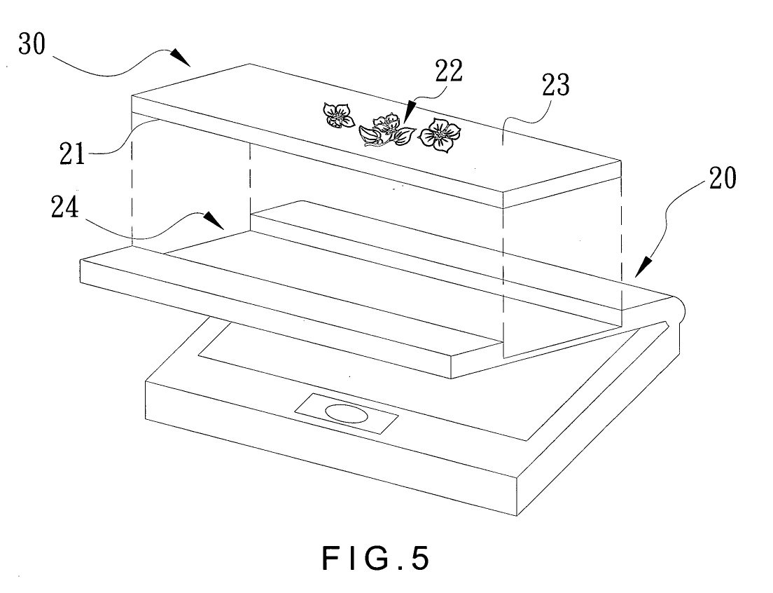

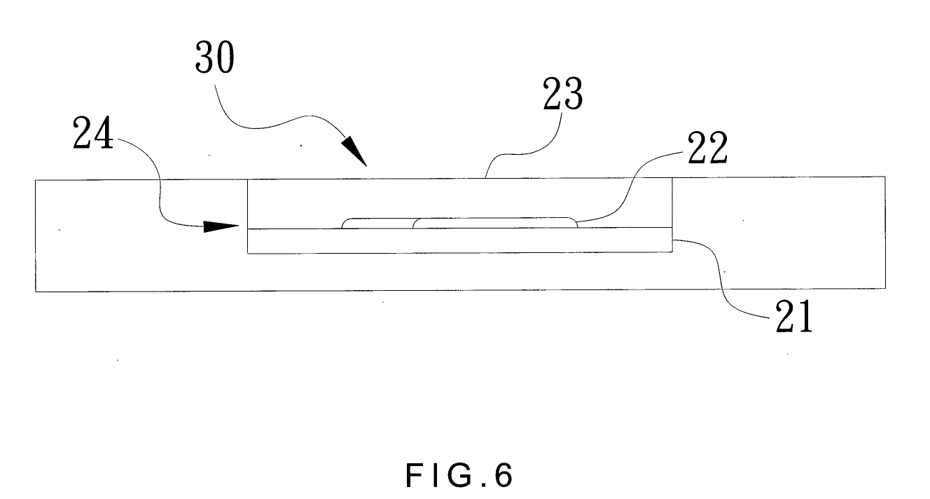

Please refer to FIG. 4 to FIG. 6 which are a perspective view, an explosive view and a sectional view showing a second preferred embodiment according to the present invention. As shown in the figures, a second preferred embodiment according to the present invention comprises a shell 20 and an image unit 30, where a notebook computer skin (the image unit 30) is prevented from being scraped or corroded and China-chic beauty and feel are obtained with ease of cleaning.

The shell 20 has a sunk area 24 on a surface; and, the image unit 30 is put in the sunk area 24. The image unit 30 comprises a metal base layer 21; an image area 22 deposed on a surface of the metal base layer 21; and a coating layer 23 covered on the metal base layer 21 and the image area 22. Therein, the shell 20 is made of an alloy of aluminum and magnesium; the image area 22 is flat or 3D hollowed-out and is deposed on the metal base layer 21; the coating layer 23 is made of a glass material and a metal oxide; the glass material is obtained by mixing with a borate or a silicate; and, the borate has boron oxide above 25% after a reduction.

When fabricating the second preferred embodiment, the shell 20 and the image unit 30 are separately made. On making the shell 20, the shell 20 is formed into a shape of a notebook computer skin with a sunk area 24. On making the image unit 30, the metal base layer 21 is formed into the shape of the sunk area 24 at first. Then, the image area 22 is hollowed out with a copper wire or a wire of other metal; and the image area 32 is burnt at 900° C. to be firmly welded on the metal base layer 21. Then the glass material and the metal oxide are coated over in the sunk area 24 and are filled into the hollowed-out image area 22; and are burnt at 750° C. to 800° C. to form a coating layer 23 above the metal base layer 21 and the image area 22. In the end, a polish is done as required. After the shell 20 and the image unit 30 are made, the image unit 30 is adhered to the shell 20 in the sunk area 24. Thus, a skin having an enameled metal structure for a notebook computer is obtained.

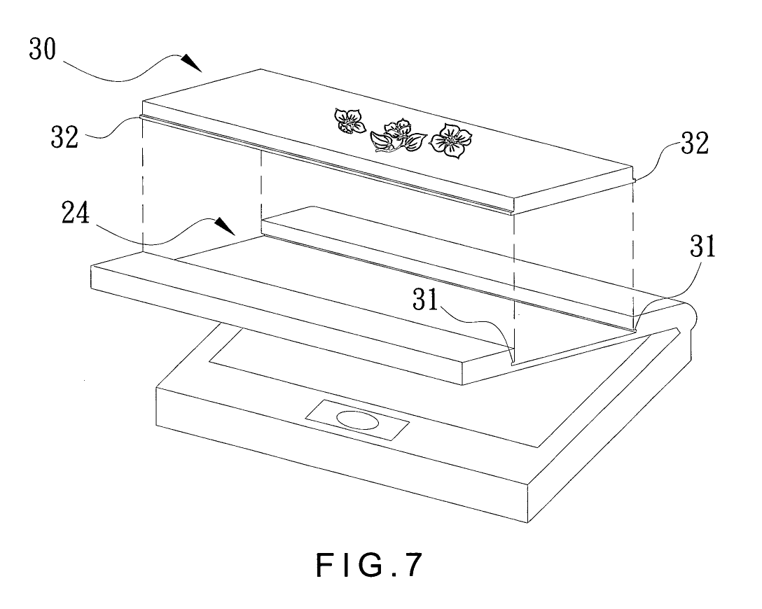

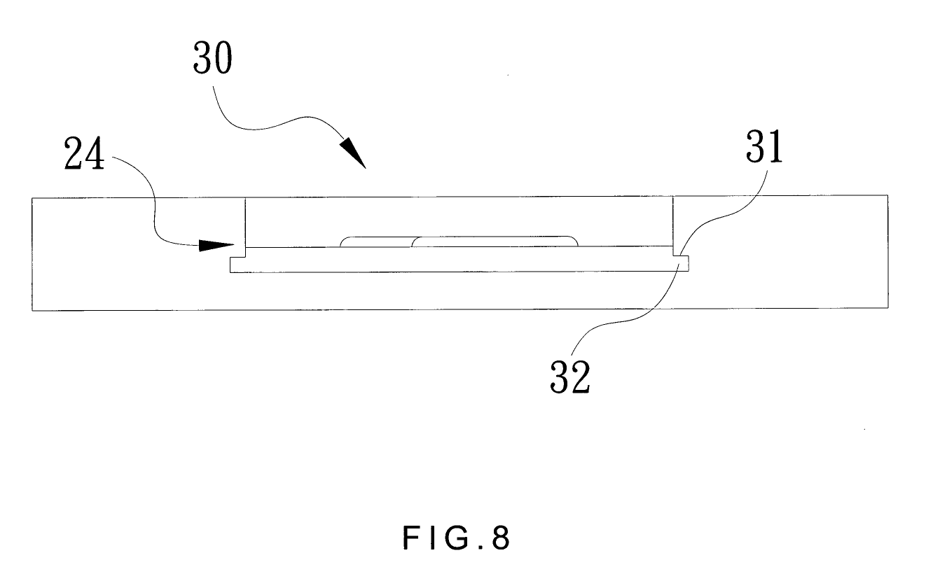

Please refer to FIG. 7 and FIG. 8, which are an explosive and a sectional views showing a third preferred embodiment. As shown in the figures, a sunk area 24 of a shell 20 has a concave 31 around on a border wall of the sunk area 24 to be locked with a convex 32 around on a border wall of an image unit 30. Hence, the image unit 30 is locked in the sunk area 24 of the shell 20 by the concave 31 and the convex 32 to obtain a skin having an enameled metal structure for a notebook computer.

To sum up, the present invention is a skin having an enameled metal structure for a notebook computer, where a notebook computer skin is prevented from being scraped or corroded and China-chic beauty and feel are obtained with ease of cleaning.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A skin having an enameled metal structure for a notebook computer, comprising:
a metal base layer;
an image area, said image area being deposed on a surface of said metal base layer; and
a coating layer, said coating layer being covered on said metal base layer and said image area,
wherein said metal base layer, said image area and said coating layer are altogether covered on a notebook computer as a skin.

2. The skin according to claim 1,
wherein said image area is flat.

3. The skin according to claim 1,
wherein said image area is three-dimensionally (3D) hollowed-out.

4. The skin according to claim 1,
wherein said coating layer is made of a glass material and a metal oxide.

5. The skin according to claim 4,
wherein said glass material of said coating layer is obtained by mixing with a salt selected from a group consisting of a borate and a silicate; and
wherein said borate has boron oxide above 25 percents (%) after a reduction.

6. A skin having an enameled metal structure for a notebook computer, comprising:
a shell, said shell having a sunk area on a surface of said shell; and
an image unit, said image unit being deposed in said sunk area, said image unit comprising:
a metal base layer;
an image area, said image area being deposed on a surface of said metal base layer; and
a coating later, said coating layer being covered on said metal base layer and said image area,
wherein said shell together with said image unit is covered on a mobile device.

7. The skin according to claim 6,
wherein said coating layer is made of a glass material and a metal oxide

8. The skin according to claim 7,
wherein said glass material is obtain by mixing with a salt selected from a group consisting of a borate and a silicate; and
wherein said borate has boron oxide above 25% after a reduction.

9. The skin according to claim 6,
wherein said shell is made of an alloy of aluminum and magnesium.

10. The skin according to claim 6,
wherein said sunk area has a concave around on a border wall of said sunk area;
wherein said image unit has a convex around on a border wall of said image unit; and
wherein said sunk area and said image unit are locked to each other by said concave and said convex.

11. The skin according to claim 6,
wherein said image unit is adhered in said sunk area.

12. The skin according to claim 6,
wherein said image area of said image unit is flat.

13. The skin according to claim 6,
wherein said image area of said image unit is 3D hollowed-out.
